(19) United States
(12) Patent Application Publication
(10) Pub. No.: US 2019/0110176 A1
(43) Pub. Date: Apr. 11, 2019

(54) ARTICULATED VEHICLE COMMUNICATION EXTENSION

(71) Applicant: Ford Global Technologies, LLC, Dearborn, MI (US)

(72) Inventors: Jakob Nikolaus HOELLERBAUER, Canton, MI (US); Cynthia M. NEUBECKER, Westland, MI (US); Perry Robinson MACNEILLE, Lathrup Village, MI (US); David Allen KOWALSKI, Toledo, OH (US); Jayanthi RAO, West Bloomfield, MI (US)

(21) Appl. No.: 16/087,634

(22) PCT Filed: Mar. 23, 2016
(86) PCT No.: PCT/US2016/023710

§ 371 Date: Sep. 22, 2018

(51) Int. Cl. H04W 4/40; H04W 4/80; H04W 76/14

(52) U.S. Cl. CPC H04W 4/40; H04W 76/14; H04W 4/80

(57) ABSTRACT

A vehicle system includes a primary transmitter and a secondary transmitter. The primary transmitter is programmed to transmit messages in accordance with a first communication protocol. The secondary transmitter is programmed to receive the messages transmitted by the primary transmitter in accordance with a second communication protocol. The secondary transmitter rebroadcasts the messages in accordance with the first communication protocol.

### BACKGROUND

Vehicle-to-vehicle (V2V) or vehicle-to-infrastructure (V2I) communication protocols (collectively, V2X), such as the Dedicated Short Range Communication (DSRC) communication protocol, allow vehicles to receive information from other vehicles and infrastructure devices, respectively. With such protocols, vehicles are able to receive information about other vehicles and infrastructure devices that is not necessarily available to human drivers. For example, a human driver of a host vehicle may observe that a nearby vehicle is travelling at about the same speed as the host vehicle. With V2V communication, however, the host vehicle may receive a signal indicating exactly how fast the nearby vehicle is travelling, it's specific location and heading, and so on.

### BRIEF DESCRIPTION OF THE DRAWINGS

FIG. 1A illustrates an example articulated vehicle with a single transmitter and a trailer causing a blind spot in signal coverage area.

FIG. 1B illustrates an example articulated vehicle with multiple transmitters that increase the overall coverage area.

FIG. 2 is a block diagram illustrating example components of the transmitters.

FIG. 3 is a flowchart of an example process that may be executed by the primary transmitter to broadcast messages.

FIG. 4 is a flowchart of an example process that may be executed by the primary transmitter when messages are received.

FIG. 5 is a flowchart of an example process that may be executed by the secondary transmitter to broadcast messages.

FIG. 6 is a flowchart of an example process that may be executed by the secondary transmitter when messages are received from nearby vehicles.

### DETAILED DESCRIPTION

Articulated vehicles, such as vehicles pulling trailers, can also benefit from V2X communications. Typically, the transmitter that facilitates the V2X communication is located in the vehicle (as opposed to the trailer). This way, the vehicle can still reap the benefits of V2X communication even if the vehicle is not pulling a trailer. In such circumstances, however, the trailer may block V2X communications by creating a communication “blind spot” behind the vehicle. Such a “blind spot” may prevent the vehicle from receiving V2X communications from other vehicles or infrastructure devices behind the trailer. Moreover, the “blind spot” may prevent vehicles and infrastructure devices located behind the trailer from receiving signals transmitted by the vehicle's transmitter.

One solution includes a vehicle system, incorporated into a host vehicle, that has a primary transmitter and a secondary transmitter. The primary transmitter is programmed to transmit messages in accordance with a first communication protocol (e.g., a V2X protocol). The secondary transmitter is programmed to receive the messages transmitted by the primary transmitter in accordance with a second communication protocol (e.g., Bluetooth® or another short-range communication protocol). The secondary transmitter rebroadcasts the messages in accordance with the first communication protocol (e.g., the V2X protocol).

Because the secondary transmitter repeats the messages from the primary transmitter, vehicles and infrastructure devices located behind the host vehicle can receive transmitted messages even though those vehicles and infrastructure devices would otherwise be in the host vehicle's blind spot. Additionally, or in the alternative, the secondary transmitter can transmit messages received from nearby vehicles and infrastructure devices to the primary transmitter. This way, the primary transmitter may receive and process messages that it would otherwise have missed due to originating from within the host vehicle's blind spot.

The elements shown may take many different forms and include multiple and/or alternate components and facilities. The example components illustrated are not intended to be limiting. Indeed, additional or alternative components and/or implementations may be used. Further, the elements shown are not necessarily drawn to scale unless explicitly stated as such.

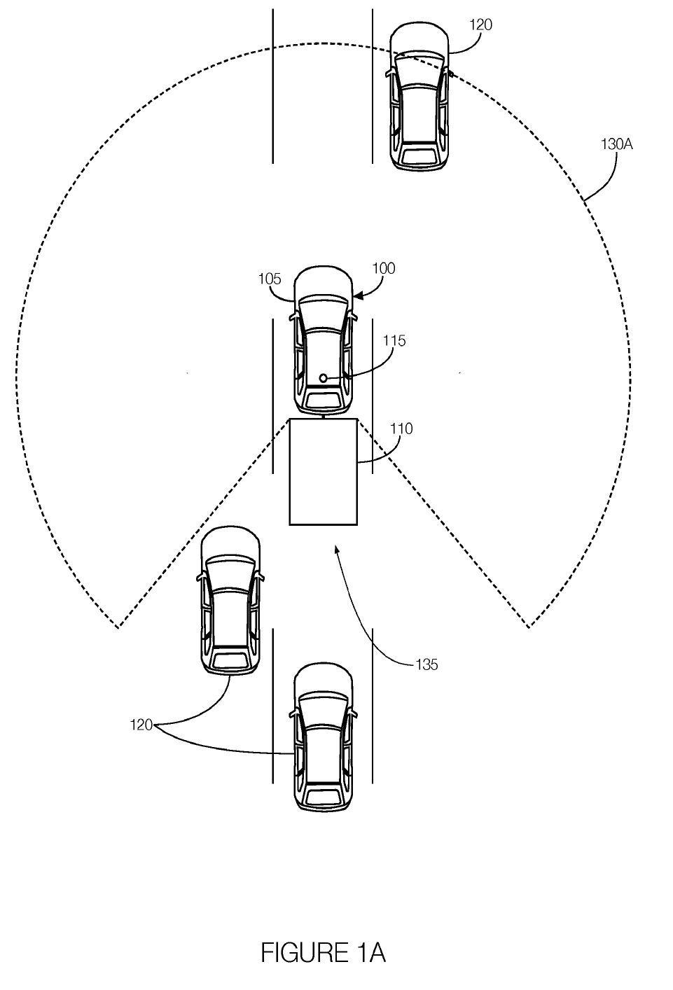

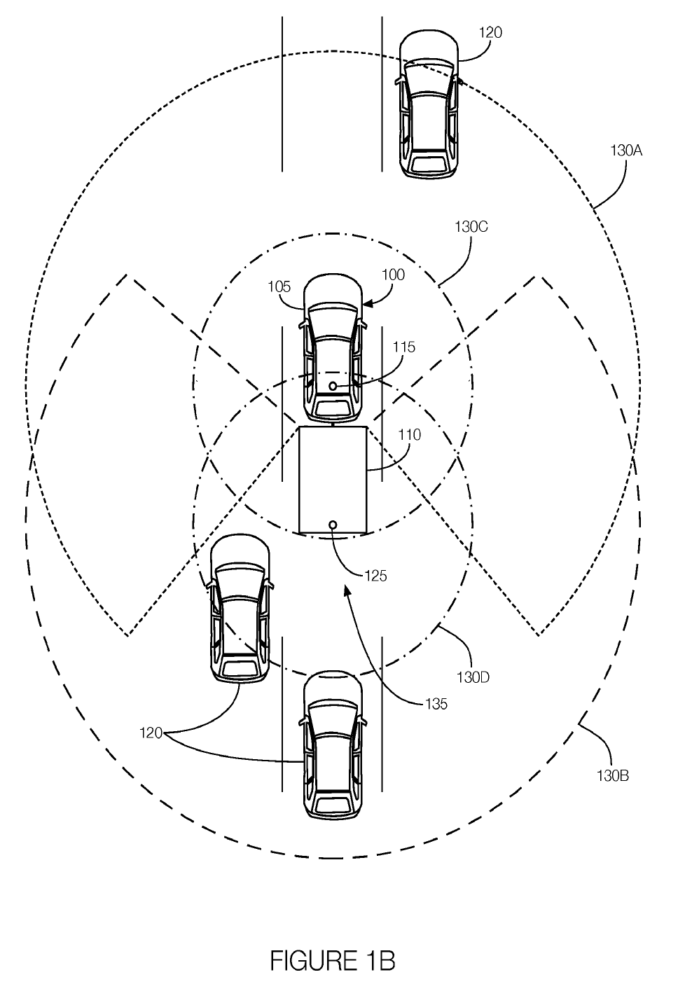

As illustrated in FIGS. 1A and 1B, the host vehicle 100, which includes a cabin 105 and is shown pulling a trailer 110, includes a primary transmitter 115. The host vehicle 100 may include any passenger or commercial automobile such as a car, a truck, a sport utility vehicle, a crossover vehicle, a van, a minivan, a taxi, a bus, etc. In some possible approaches, the host vehicle 100 is an autonomous vehicle that operates in an autonomous (e.g., driverless) mode, a partially autonomous mode, or a non-autonomous mode.

The primary transmitter 115 includes any number of electronic circuits and antennas that, when connected, facilitate wireless communication with nearby vehicles 120 and a secondary transmitter 125 (see FIG. 1B), as discussed in greater detail below. The primary transmitter 115 may be programmed to transmit messages to nearby vehicles 120, receive messages from the nearby vehicles 120, or both. By way of example, the primary transmitter 115 may be a wireless router. The primary transmitter 115 may be programmed to communicate with the nearby vehicles 120 according to any number of wireless communication protocols such as a vehicle-to-vehicle (V2V) communication protocol, a vehicle-to-infrastructure (V2I) communication protocol, or the like (referred to as a “first communication protocol”). For example, the primary transmitter 115 may be programmed to communicate in accordance with the dedicated short range communication (DSRC) communication protocol. The primary transmitter 115 is associated with a coverage area 130A (referred to as the “primary coverage area”), meaning that the primary transmitter 115 transmits signals at a power such that receivers in the coverage area 130A are able to receive the signals transmitted by the primary transmitter 115. Thus, nearby vehicles 120 with appropriately equipped receives, located in the coverage area 130A may receive signals transmitted by the primary transmitter 115.

The primary transmitter 115 may be located in the cabin 105, which could include a passenger compartment, a cargo area, or both, of the host vehicle 100. Moreover, as discussed in greater detail below, the primary transmitter 115 may be programmed to pair with a secondary transmitter 125, shown in FIG. 1B, via a different communication protocol than used to communicate with nearby vehicles 120 or infrastructure devices. For example, the primary transmitter 115 may be programmed to communicate with the secondary transmitter 125 via, e.g., Bluetooth® or another short-range wireless communication protocol (referred to as a “second communication protocol”). In some instances, instead of wireless communication, the primary transmitter 115 and the second transmitter may be programmed to communicate via a wired communication link.

Referring now to FIG. 1B, the secondary transmitter 125 includes any number of electronic circuits and antennas that, when connected, facilitate wireless communication with nearby vehicles 120 and the primary transmitter 115. Like the primary transmitter 115, the secondary transmitter 125 may be programmed to transmit messages to nearby vehicles 120, receive messages from other vehicles, or both, and the secondary transmitter 125 may be programmed to communicate with the nearby vehicles 120 according to any number of wireless communication protocols such as a vehicle-to-vehicle (V2V) communication protocol, a vehicle-to-infrastructure (V2I) communication protocol, or the like (i.e., the first communication protocol). For example, the secondary transmitter 125 may be programmed to communicate in accordance with the dedicated short range communication (DSRC) communication protocol. By way of example, the secondary transmitter 125 may be a wireless router or repeater.

The secondary transmitter 125 is associated with a coverage area 130B (referred to as the “secondary coverage area”), meaning that the secondary transmitter 125 transmits signals at a power such that receivers in the coverage area 130B are able to receive the signals transmitted by the secondary transmitter 125. Thus, nearby vehicles 120 with appropriately equipped receives, located in the coverage area 130B may receive signals transmitted by the secondary transmitter 125. The secondary transmitter 125 may be located in or on the trailer 110 towed by the host vehicle 100 and may be programmed to pair with the primary transmitter 115 via a different communication protocol than used to communicate with nearby vehicles 120 or infrastructure devices. For example, as discussed above, the primary transmitter 115 and secondary transmitter 125 may be programmed to communicate via, e.g., Bluetooth® or another short-range wireless communication protocol (i.e., the second communication protocol) such as Bluetooth LE®, Zigbee®, ANT® multicast wireless sensor network, or the like. In some instances, instead of wireless communication, the primary transmitter 115 and the second transmitter may be programmed to communicate via a wired communication link.

Referring now to FIGS. 1A and 1B, the trailer 110 may cause a communication blind spot 135 behind the cabin 105. In other words, the trailer 110 may partially block or attenuate signals transmitted by the primary transmitter 115, reducing the coverage area 130A of the primary transmitter 115. The same blind spot 135 may prevent the primary transmitter 115 from receiving signals, transmitted from nearby vehicles 120, that originate within the blind spot 135. The coverage area 130B of the secondary transmitter 125 at least partially addresses that issue. Because the secondary transmitter 125 is located in or on the trailer 110, the signals transmitted by the secondary transmitter 125 are not attenuated by the trailer 110 in the same way as the signals transmitted by the primary transmitter 115. Thus, the coverage area 130B may fill the blind spot 135.

As discussed above, the direct communication between the primary transmitter 115 and the secondary transmitter 125 is via the second communication protocol. The secondary transmitter 125 may receive messages, transmitted by the primary transmitter 115, via the second communication protocol and broadcast those messages to nearby vehicles 120, including nearby vehicles 120 in the blind spot 135, via the first communication protocol. The coverage areas 130C and 130D for this direct communication between the primary transmitter 115 and the secondary transmitter 125 may be significantly smaller than the coverage areas 130A and 130B. Also, although no blind spot 135 is shown with regard to coverage areas 130C and 130D, a small blind spot 135 may exist. As discussed below, however, that small blind spot 135 may not prevent the direct communication between the primary transmitter 115 and the secondary transmitter 125 in accordance with the second communication protocol.

The primary transmitter 115 and secondary transmitter 125 may be located in the cabin 105 and trailer 110, respectively, at locations that are not within the blind spot 135. For instance, the secondary transmitter 125 may be located on top of the trailer 110 and the primary transmitter 115 may be located on top of the host vehicle 100. Alternatively, the primary transmitter 115 and secondary transmitter 125s may still be able to communicate despite being in each other's blind sports. For instance, the blind spot 135 caused by the trailer 110 may simply attenuate the signals, which would reduce but not completely blocking all wireless communication. Therefore, even with the blind spot 135, the primary transmitter 115 and secondary transmitter 125 may still be able to communicate according to the first communication protocol, the second communication protocol, or both, if located close enough to one another. In other words, while the blind spot 135 caused by the trailer 110 may prevent the primary transmitter 115 from communicating with certain nearby vehicles 120, it may not prevent the primary transmitter 115 from communicating with the secondary transmitter 125.

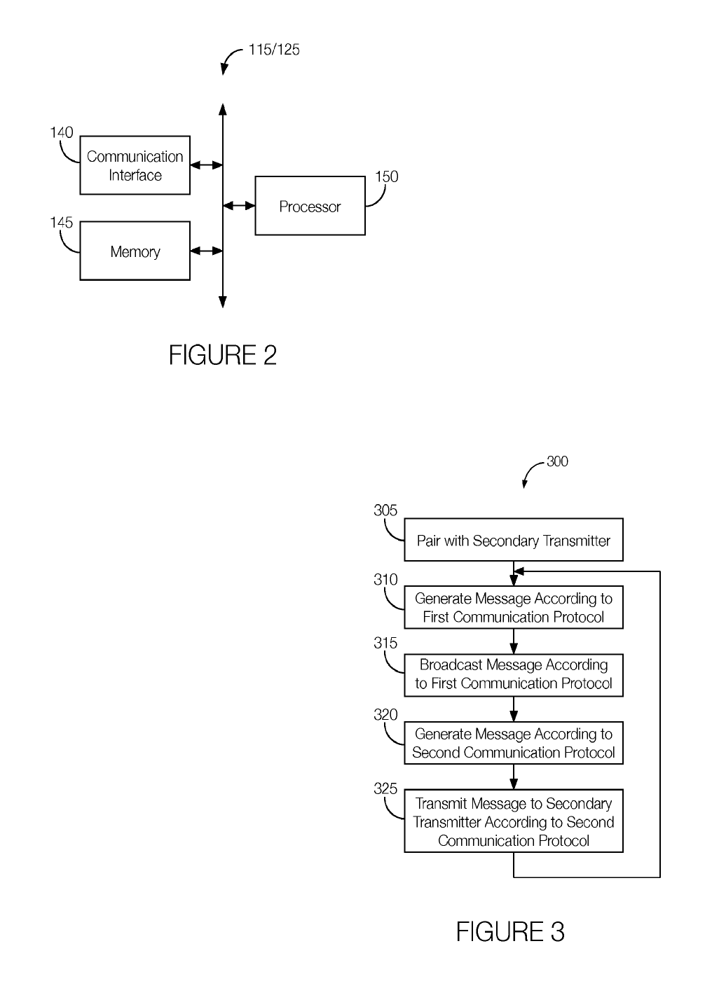

FIG. 2 illustrates example components of the primary transmitter 115, the secondary transmitter 125, or both. As shown, the primary transmitter 115 and secondary transmitter 125 each include a communication interface 140, a memory 145, and a processor 150.

The communication interface 140 may include any number of electronic components, such as circuits and at least one antenna, that can wirelessly transmit and receive signals. In some possible implementations, the communication interface 140 may facilitate pairing between the primary transmitter 115 and the secondary transmitter 125. Moreover, the communication interface 140 may be programmed to generate signals that include messages and transmit the signals according to various communication protocols including the first communication protocol and the second communication protocol. Thus, the communication interface 140 incorporated into the primary transmitter 115 may be programmed to broadcast messages to nearby vehicles 120 and transmit messages to the secondary transmitter 125. The communication interface 140 incorporated into the secondary transmitter 125 may be programmed to broadcast messages to nearby vehicles 120 and transmit messages to the primary transmitter 115. The communication interfaces 140 incorporated into both the primary transmitter 115 and the secondary transmitter 125 may be programmed to receive signals transmitted from nearby vehicles 120.

The memory 145 may include any number of electronic components, such as circuits and data storage media, that can electronically store data. The memory 145 may store, e.g., computer-executable instructions, data associated with the operation of the host vehicle 100, data received from nearby vehicles 120, or the like. The data stored in the memory 145 may be accessible to other components such as the communication interface 140, the processor 150, or both.

The processor 150 may include any number of electronic components, such as circuits and a central processing unit (CPU), that can access the data stored in the memory 145 and execute instructions, including instructions stored in the memory 145. The instructions may relate pairing with the other transmitter in accordance with the second communication protocol and commanding the communication interface 140 to broadcast messages to nearby vehicles 120 in accordance with the first communication protocol.

For instance, the processor 150 incorporated into the primary transmitter 115 may be programmed to generate messages that include various vehicle data stored in the memory 145 and command the communication interface 140 to broadcast the messages to nearby vehicles 120 according to the first communication protocol and to the secondary transmitter 125 in accordance with the second communication protocol. The processor 150 incorporated into the primary transmitter 115 may be further programmed to receive and process signals received from nearby vehicles 120 whether received directly from the nearby vehicle 120 or received via the secondary transmitter 125. Since there are circumstances in which the primary transmitter 115 may receive the same signals from both the secondary transmitter 125 and directly from nearby vehicles 120, the processor 150 incorporated into the primary transmitter 115 may be programmed to determine whether a received signal is a duplicate signal and ignore any duplicate signals received. The processor 150 may, for example, determine whether a signal is a duplicate based on data incorporated into the signal. Such data may include, e.g., an indicator of the vehicle from which the signal originated, a timestamp, the contents of the message, etc.

Further, the processor 150 incorporated into the primary transmitter 115 may be programmed to ignore other types of messages received from nearby vehicles 120 via the first communication protocol. For example, some messages may be addressed to particular vehicles yet broadcast to all vehicles within range, which could include the host vehicle 100. If the primary transmitter 115 receives such a signal either directly from one of the nearby vehicles 120 or via the secondary transmitter 125, the processor 150 incorporated into the primary transmitter 115 may be programmed to determine, from the data incorporated into the received signal, that the message is addressed to a different vehicle and ignore the message.

The processor 150 incorporated into the secondary transmitter 125 may be programmed to receive messages from the primary transmitter 115 via the second communication protocol and command the communication interface 140 incorporated into the secondary processor 150 to broadcast the received messages to nearby vehicles 120 via the first communication protocol. This way, nearby vehicles 120 in the blind spot 135 of the primary transmitter 115 may still receive signals broadcast by the primary transmitter 115.

The processor 150 incorporated into the secondary transmitter 125 may be further programmed to receive signals from nearby vehicles 120 in accordance with the first communication protocol and transmit those signals to the primary transmitter 115 via the second communication protocol. That way, the processor 150 incorporated into the primary transmitter 115 can receive and process signals that originate in the blind spot 135 of the primary transmitter 115.

Like the processor 150 incorporated into the primary transmitter 115, the processor 150 incorporated into the secondary transmitter 125 may be programmed to ignore messages intended for other vehicles. That is, the processor 150 incorporated into the secondary transmitter 125 may be programmed to receive and process a signal from a nearby vehicle 120, determine that the message incorporated into the signal is meant for a different vehicle, and ignore the message. Ignoring the message may include, e.g., not transmitting the message to the primary transmitter 115 via the second communication protocol. Put another way, the processor 150 incorporated into the secondary transmitter 125 may be programmed to forward, to the primary transmitter 115 in accordance with the second communication protocol, messages addressed to the host vehicle 100 or that are meant for all vehicles, including the host vehicle 100. Alternatively, the processor 150 incorporated into the secondary transmitter 125 may be programmed to transmit all received messages to the primary transmitter 115 so, e.g., the processor 150 incorporated into the primary transmitter 115 can determine whether or not to ignore the message.

FIG. 3 is a flowchart of an example process 300 that may be executed by the primary transmitter 115 to transmit messages to nearby vehicles 120 despite a blind spot 135 caused by the trailer 110. The process 300 may be executed at any time while the host vehicle 100 is running and may continue to execute until, e.g., the host vehicle 100 is shut off.

At block 305, the primary transmitter 115 may pair with the secondary transmitter 125. The pairing may be facilitated in response to a command generated by the processor 150 of the primary transmitter 115, the secondary transmitter 125, or both. The pairing between the primary transmitter 115 and the secondary transmitter 125 may be further facilitated by their respective communication interfaces 140, and the communication associated with the pairing may be in accordance with the second communication protocol.

At block 310, the primary transmitter 115 may generate a message. The processor 150 of the primary transmitter 115 may, for instance, generate the message based on instructions and data stored in the memory 145 and command the communication interface 140 to broadcast the message according to the first communication protocol.

At block 315, the primary transmitter 115 may broadcast the message generated at block 310 to nearby vehicles 120. For example, in response to the command generated at block 310, the communication interface 140 may broadcast the message according to the first communication protocol.

At block 320, the primary transmitter 115 may generate the message according to the second communication protocol. That is, the processor 150 incorporated into the primary transmitter 115 may, for example, command the communication interface 140 to transmit the message generated at block 310 to the secondary transmitter 125 in accordance with the second communication protocol. In some instances, the message may further include an instruction for the secondary transmitter 125 to rebroadcast the message.

At block 325, the primary transmitter 115 may transmit the message to the secondary transmitter 125 according to the second communication protocol. For instance, the communication interface 140 of the primary transmitter 115 may, in response to the command generated at block 320, transmit the message to the secondary transmitter 125, with the instruction to rebroadcast the message, in accordance with the second communication protocol. By broadcasting the message to nearby vehicles 120 via the first communication protocol, sending the same message to the secondary transmitter 125 via the second communication protocol, and instructing the secondary transmitter 125 to rebroadcast the message via the first communication protocol, the blind spot 135 may be effectively reduced or eliminated.

The process 300 may return to block 310 so that additional messages may be generated, broadcast, and rebroadcast while the host vehicle 100 is operating.

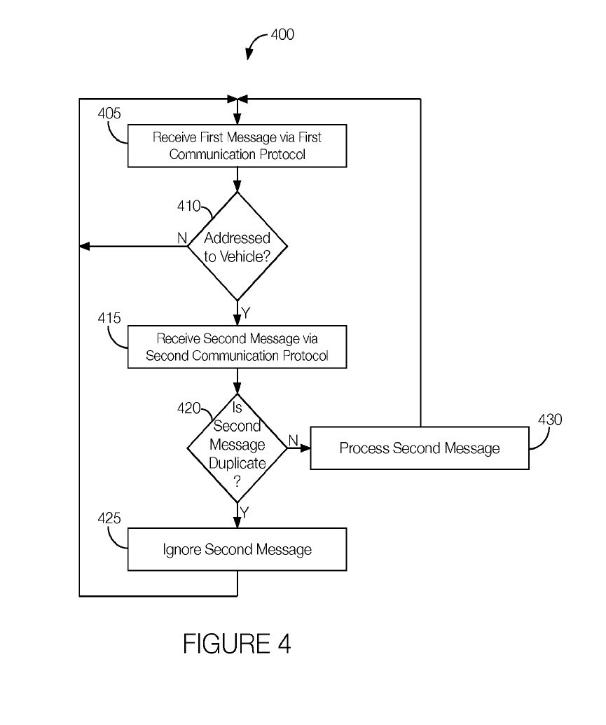

FIG. 4 is a flowchart of an example process 400 that may be executed by the primary transmitter 115 when messages are received. The process 400 may be executed at any time while the host vehicle 100 is running and may continue to execute until, e.g., the host vehicle 100 is shut off.

At block 405, the primary transmitter 115 may receive a first message via the first communication protocol. The first message may be received from the secondary transmitter 125 or a nearby vehicle 120. The antenna incorporated into the communication interface 140 may receive the first message, and the processor 150 incorporated into the primary transmitter 115 may begin to process the first message. Processing the first message at block 405 may include, e.g., extracting data from the first message. The data may identify the sender of the first message, the intended recipient of the first message, a timestamp, as well as other information.

At decision block 410, the primary transmitter 115 may determine whether the first message is addressed to the host vehicle 100. The processor 150 incorporated into the primary transmitter 115 may make such a determination based on the data included in the message. If the primary transmitter 115 determines that the first message is addressed to the host vehicle 100, the process 400 may proceed to block 415. Otherwise, the first message may be ignored and the process 400 may return to block 405 to await a subsequent message.

At block 415, the primary transmitter 115 may receive a second message via the second communication protocol. The second message may be received from the secondary transmitter 125. The antenna incorporated into the communication interface 140 may receive the second message, and the processor 150 incorporated into the primary transmitter 115 may begin to process the second message. Processing the second message at block 415 may include, e.g., extracting data from the second message. The data may identify the sender of the first message, the intended recipient of the first message, a timestamp, as well as other information.

At decision block 420, the primary transmitter 115 may determine whether the second message is a duplicate. For instance, the second message may be a duplicate of the first message if, e.g., the first message was received from a nearby vehicle 120 via the first communication protocol and the second message was sent to the primary transmitter 115 via the second communication protocol after the secondary transmitter 125 received the second message from the nearby vehicle 120. To determine whether the second message is a duplicate, the processor 150 of the primary transmitter 115 may consider the data accessed at blocks 405 and 415. That is, the processor 150 may determine whether the first message and second message are identical based on the sender of the first and second messages, the intended recipients of the first and second messages, the timestamps of the first and second messages, etc. If the second message is a duplicate of the first message, the process 400 may proceed to block 425. Otherwise, the process 400 may proceed to block 430.

At block 425, the primary transmitter 115 may ignore the second message. Ignoring the second message may include deleting the second message or storing the second message, at least temporarily, in the memory 145 for archive purposes. The decision of how to ignore the second message (e.g., whether it should be deleted or archived) may be made by the processor 150 of the primary transmitter 115. The process 400 may proceed to block 405 to await additional messages.

At block 430, the primary transmitter 115 may continue to process the second message. For instance, the processor 150 incorporated into the primary transmitter 115 may extract additional information from the message and store the contents of the message, at least temporarily, in the memory 145. The process 400 may proceed to block 405 to await additional messages.

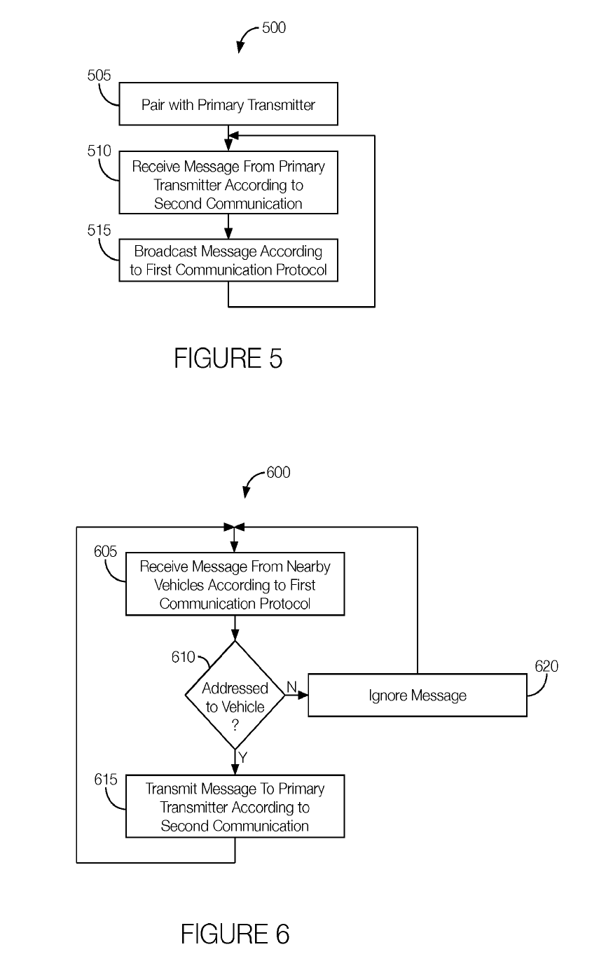

FIG. 5 is a flowchart of an example process 500 that may be executed by the secondary transmitter 125 to broadcast messages created by the primary transmitter 115. The process 500 may be executed at any time while the host vehicle 100 is running and may continue to execute until, e.g., the host vehicle 100 is shut off.

At block 505, the secondary transmitter 125 may pair with the primary transmitter 115. The pairing may be facilitated in response to a command generated by the processor 150 of the primary transmitter 115, the secondary transmitter 125, or both. The pairing between the primary transmitter 115 and the secondary transmitter 125 may be further facilitated by their respective communication interfaces 140, and the communication associated with the pairing may be in accordance with the second communication protocol.

At block 510, the secondary transmitter 125 may receive messages generated by the primary transmitter 115. The messages may be received via, e.g., the communication interface 140 incorporated into the secondary transmitter 125. The messages received at block 510 may be the same messages generated at block 310 and transmitted by the primary transmitter 115 broadcast at block 315. The secondary transmitter 125, however, may receive those messages via the second communication protocol instead of the first communication protocol after the primary transmitter 115 transmits the message at block 325. In some instances, the secondary transmitter 125 may be close enough to the primary transmitter 115 that the secondary transmitter 125 is able to receive the message via the first communication protocol as well as the second communication protocol. In such instances, the processor 150 of the secondary transmitter 125 may be programmed to ignore any duplicate messages received via the first communication protocol.

At block 515, the secondary transmitter 125 may broadcast the message received at block 510 to nearby vehicles 120. For example, the communication interface 140 incorporated into secondary transmitter 125 may broadcast the message according to the first communication protocol in response to receiving the message at block 530 and in response to a command generated by the processor 150 incorporated into the secondary transmitter 125. The process 500 may proceed to block 505 to await additional messages.

By receiving the messages via the second communication protocol and broadcasting the messages via the second communication protocol from within the blind spot 135, the secondary transmitter 125 can effectively reduce or eliminate the blind spot 135 of the primary transmitter 115 caused by, e.g., the trailer 110.

FIG. 6 is a flowchart of an example process 600 that may be executed by the secondary transmitter 125 when messages are received from nearby vehicles 120. The process 600 may be executed at any time while the host vehicle 100 is running and may continue to execute until, e.g., the host vehicle 100 is shut off.

At block 605, the secondary transmitter 125 may receive a message via the first communication protocol from one of the nearby vehicles 120. The antenna incorporated into the communication interface 140 of the secondary transmitter 125 may receive the message, and the processor 150 incorporated into the secondary transmitter 125 may begin to process the message. Processing the message at block 605 may include, e.g., extracting data from the message. The data may identify the sender of the message, the intended recipient of the message, a timestamp, as well as other information.

At decision block 610, the secondary transmitter 125 may determine whether the message is addressed to the host vehicle 100. The processor 150 incorporated into the secondary transmitter 125 may make such a determination based on the data included in the message. If the secondary transmitter 125 determines that the message is addressed to the host vehicle 100, the process 600 may proceed to block 615. Otherwise, the process 600 may proceed to block 620.

At block 615, the secondary transmitter 125 may transmit the message received at block 605 to the primary transmitter 115. Transmitting the message to the primary transmitter 115 may include, e.g., the processor 150 incorporated into the secondary transmitter 125 commanding the communication interface 140 of the secondary transmitter 125 to transmit the message to the primary transmitter 115 in accordance with the second communication protocol. The process 600 may proceed to block 605 to await further messages from nearby vehicles 120.

At block 620, the secondary transmitter 125 may ignore the message received at block 605. Ignoring the message may include deleting the message or storing the message, at least temporarily, in the memory 145 of either the primary transmitter 115 or the secondary transmitter 125 for archive purposes. The decision of how to ignore the message (e.g., whether it should be deleted or archived) may be made by the processor 150 of the secondary transmitter 125. After block 620, the process 600 may return to block 605 to await a subsequent message.

In general, the computing systems and/or devices described may employ any of a number of computer operating systems, including, but by no means limited to, versions and/or varieties of the Ford Sync® application, AppLink/Smart Device Link middleware, the Microsoft Automotive® operating system, the Microsoft Windows® operating system, the Unix operating system (e.g., the Solaris® operating system distributed by Oracle Corporation of Redwood Shores, Calif.), the AIX UNIX operating system distributed by International Business Machines of Armonk, N.Y., the Linux operating system, the Mac OSX and iOS operating systems distributed by Apple Inc. of Cupertino, Calif., the BlackBerry OS distributed by Blackberry, Ltd. of Waterloo, Canada, and the Android operating system developed by Google, Inc. and the Open Handset Alliance, or the QNX® CAR Platform for Infotainment offered by QNX Software Systems. Examples of computing devices include, without limitation, an on-board vehicle computer, a computer workstation, a server, a desktop, notebook, laptop, or handheld computer, or some other computing system and/or device.

Computing devices generally include computer-executable instructions, where the instructions may be executable by one or more computing devices such as those listed above. Computer-executable instructions may be compiled or interpreted from computer programs created using a variety of programming languages and/or technologies, including, without limitation, and either alone or in combination, Java™, C, C++, Visual Basic, Java Script, Perl, etc. Some of these applications may be compiled and executed on a virtual machine, such as the Java Virtual Machine, the Dalvik virtual machine, or the like. In general, a processor (e.g., a microprocessor) receives instructions, e.g., from a memory 145, a computer-readable medium, etc., and executes these instructions, thereby performing one or more processes, including one or more of the processes described herein. Such instructions and other data may be stored and transmitted using a variety of computer-readable media.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of a computer. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary.

The Abstract is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A vehicle system comprising:
a primary transmitter programmed to transmit messages in accordance with a first communication protocol; and
a secondary transmitter programmed to receive the messages transmitted by the primary transmitter in accordance with a second communication protocol and rebroadcast the messages in accordance with the first communication protocol.

2. The vehicle system of claim 1, wherein the primary transmitter is programmed to pair with the secondary transmitter.

3. The vehicle system of claim 2, wherein the primary transmitter is programmed to pair with the secondary transmitter according to the second communication protocol.

4. The vehicle system of claim 1, wherein the secondary transmitter is programmed to receive messages addressed to a host vehicle associated with the primary transmitter.

5. The vehicle system of claim 4, wherein the secondary transmitter is programmed to receive the messages addressed to the host vehicle associated with the primary transmitter in accordance with the first communication protocol.

6. The vehicle system of claim 5, wherein the secondary transmitter is programmed to transmit, to the primary transmitter, the messages addressed to the host vehicle.

7. The vehicle system of claim 6, wherein the secondary transmitter is programmed to transmit, to the primary transmitter, the messages addressed to the host vehicle in accordance with the second communication protocol.

8. The vehicle system of claim 6, wherein the primary transmitter is programmed to determine whether messages, addressed to the host vehicle and received from the secondary transmitter, are duplicate messages.

9. The vehicle system of claim 8, wherein the primary transmitter is programmed to ignore duplicate messages.

10. The vehicle system of claim 1, wherein the first communication protocol includes a Dedicated Short Range Communication protocol.

11. The vehicle system of claim 1, wherein the second communication protocol includes at least one of a Bluetooth communication protocol, a Bluetooth LE communication protocol, a Zigbee communication protocol, an ANT communication protocol.

12. The vehicle system of claim 1, wherein the primary transmitter and the secondary transmitter communicate wirelessly in accordance with the first communication protocol and the second communication protocol.

13. A vehicle comprising:
a primary transmitter located in a vehicle cabin and programmed to transmit messages in accordance with a first communication protocol; and
a secondary transmitter located in a vehicle trailer and programmed to receive the messages transmitted by the primary transmitter in accordance with a second communication protocol and rebroadcast the messages in accordance with the first communication protocol.

14. The vehicle system of claim 13, wherein the primary transmitter is programmed to wirelessly pair with the secondary transmitter according to the second communication protocol.

15. The vehicle system of claim 13, wherein the secondary transmitter is programmed to receive messages addressed to a host vehicle associated with the primary transmitter and in accordance with the first communication protocol.

16. The vehicle system of claim 15, wherein the secondary transmitter is programmed to transmit, to the primary transmitter, the messages addressed to the host vehicle in accordance with the second communication protocol.

17. The vehicle system of claim 16, wherein the primary transmitter is programmed to determine whether messages, addressed to the host vehicle and received from the secondary transmitter, are duplicate messages.

18. The vehicle system of claim 17, wherein the primary transmitter is programmed to ignore duplicate messages.

19. The vehicle system of claim 13, wherein the first communication protocol includes a Dedicated Short Range Communication protocol and wherein the second communication protocol includes the Bluetooth communication protocol.
